(19) United States
(12) Patent Application Publication
(10) Pub. No.: US 2005/0061115 A1
(43) Pub. Date: Mar. 24, 2005

(54) Wrench device

(75) Inventors: Seamus Duffy, Lanesborough (IE); Nigel Buchanan, Fife (GB)

Correspondence Address: CONNOLLY BOVE LODGE & HUTZ LLP, SUITE 800, 1990 M STREET NW, WASHINGTON, DC, 20036-3425, US

(73) Assignee: Smart Tools Ltd.

(21) Appl. No.: 10/493,469

(22) PCT Filed: Oct. 30, 2002
(86) PCT No.: PCT/GB02/04882

(30) Foreign Application Priority Data
Oct. 30, 2001 (IE) 2001/0953

(51) Int. Cl. B25B 13/52

(52) U.S. Cl. 81/64

(57) ABSTRACT

A wrench (1) is disclosed having a handle (3), a head portion (2) for engaging a drive socket (4) to tighten or slacken a fastener such as a nut, bolt or screw, and an operative portion (9) intermediate the handle and head portion. The head portion (2) is a flexible ring (2a) having a radial gap (2g) therein and an arm (2c, 2e) extending radially outwardly from each end of the ring respectively. The arms, preferably of unequal lengths, are mounted on the operative part (9) so that when the handle (3) is rotated in a drive direction (D) the head portion (2) clamps onto the drive socket (4) with increasing pressure as drive torque increases through rotation of the handle. Movement of the handle (3) in the opposite direction (R) allows free rotation of the head portion (2) relative to the drive socket (4).

### FIELD OF THE INVENTION

The present invention relates to a wrench device having a one way operation and more particularly, though not exclusively, concerns a tool similar in operation to a ratchet like tool having a ratchet bar.

### BACKGROUND OF THE INVENTION

Ratchet tools are well known and are a tool suitable for applying torque to a fastener such as a nut, bolt or screw, via an appropriate drive socket (hereinafter also referred to as a fastening device) having a square drive recess which receives a square peg of a ratchet bar, for the purpose of tightening or slackening the fastener. The wrench or ratchet tool is movable relative to the fastening device in one direction only opposite to that direction in which torque is applied. Motion between the ratchet bar and the fastening device in the opposite direction is achieved by a set of angular teeth, which co-operate with a pawl to create a locking motion in the one direction only for applying torque and free movement in the opposite direction. The operation of the fastening device and fastener via a ratchet bar is much more convenient in restricted space situations than the use of a fixed bar operated socket because there is seldom a requirement to remove and reattach the fastening device operating the fastener.

Variations of known ratchet bar arrangements are exhaustive. Most mechanisms have more and more locking teeth etc. to allow a smaller angle between drive, re-position and drive, resulting in mechanisms in which the angle between drive and reposition has been substantially reduced, but as a result so has the amount of torque that can be safely applied to the ratchet bar without failure. The increasing intricacies of the ratchet mechanisms have resulted in them being intolerant to dirt or corrosion.

### SUMMARY OF THE INVENTION

It is an object of the present invention to provide an improved one directional drive device in particular a fastening device.

According to one aspect of the present invention there is provided a wrench device comprising a handle and resiliently movable clamping means mounted on the handle, the clamping means comprising spaced means for connecting the clamping means with the handle, the spaced means being located at offset locations both laterally and longitudinally relative to a longitudinal axis of the handle so that movement of the handle in a drive direction moves the spaced means one relative to the other to clamp the clamping means on a fastener for moving the fastener.

In a preferred embodiment of the present invention the clamping means has two spaced ends movable towards each other to effect clamping to turn the fastening device, or movable away from each other to release the clamping force. Preferably, each spaced end of the resilient movable clamping member has an arm, extending radially outwardly therefrom. The arms are conveniently of unequal length and preferably extend outwardly side-by-side closely spaced one from the other.

Conveniently, the end of each arm remote from the resilient movable clamping member has an aperture therethrough. The aperture at the end of each arm can be arranged to receive pivot means located on the handle.

Preferably, the pivot means comprises a pivot pin in each instance supported between two spaced plates extending axially of the handle. Conveniently, there is provided a stop pin supported between the spaced plates, for preventing movement of one arm when releasing the wrench from driving the fastening device.

It is preferred that the handle is elongate and secured to the two spaced plates on the diametrically opposite side of the pivot pin remote from the resilient movable means.

The resilient movable means may comprise an annular ring element having a gap defined by spaced ends thereof.

Therefore, there has been provided a wrench comprising a clamp drive socket bar which can grip a spigot of a fastening device instantly when used in a drive direction, yet freewheel easily about the spigot when rotated in an opposite direction. When torque is applied to the clamped drive socket bar to tighten or release a fastener the action of the clamp drive socket bar is to increase the locking action on the fastening device or socket drive the more torque is applied, thereby assisting tightening or release of the fastener.

The clamp drive socket bar has a head portion adapted to engage and apply torque to a fastening device such as a socket or drive bit to rotate a fastener. The head portion preferably includes a flexible ring having a cylindrical type inner working surface for engaging a cylindrical drive part of the socket drive. When torque is applied to the head portion of the ratchet bar in a fastening direction, the flexible ring closes and grips the outer surface of the fastening device/spigot of the socket drive. In an alternative embodiment the socket drive can be replaced by a cylindrical drive socket which has a preferably square shaped central aperture lying coaxially with a central axis of the drive socket for engagement by a known socket with square drive to thereby turn a known fastener.

Preferably, the flexible ring and handle portion are sandwiched between adjacent plates. The plates are conveniently fixed to the handle portion on one side thereof respectively by pins, such as rivets. Other such pins act as spigots in operating the fastening device.

The flexible ring is conveniently located on two fixed spigots spaced axially and laterally relative to the longitudinal axis of the handle of the clamp drive socket bar. One spigot conveniently supports one, a shorter one, of two arms extending radially outwardly from the flexible ring, and a second spigot supports the second, longer one, of the two radially extending arms. Each of the shorter and longer arms extends outwardly from opposed ends, respectively, of the flexible ring, which ends define a space therebetween for the purpose of allowing the diameter of the flexible ring to contract or expand.

The second of the adjacent plates is fixedly mounted on the handle and lies adjacent the flexible ring on the side thereof opposite to that side of the handle against which the first of the adjacent plates lies.

The flexible ring is movable while being held between the adjacent plates of the handle portion via an axis pin on the larger arm of the flexible ring and a fulcrum pin on the smaller arm of the flexible ring.

When such a fastening device is mounted over a fastener and the handle portion of the socket bar is rotated in the drive direction, the handle rotates relative to the axis pin. The fulcrum pin acts on the smaller arm of the flexible ring closing the flexible ring around the shoulder drive of the socket thereby locking the flexible ring and socket together to enable the fastener to be rotated.

When the clamp drive socket bar is moved in an opposite or reverse direction the grip of the flexible ring is released and the friction between the inner cylindrical surface of the flexible ring and the external surface of the spigot drive of the fastening device is very much reduced because the flexible ring opens sufficiently for the flexible ring to rotate freely about the spigot drive of the socket. The larger arm of the flexible ring may be prevented from moving further away from the shorter arm under the spring bias within the flexible ring by a reverse/spring stop pin.

Preferably, the inside cylindrical gripping surface of the flexible ring is a fine smooth finish.

Preferably, the gripping surface of the spigot drive of the socket is a fine smooth finish.

Conveniently, the flexible ring has a sprung grip on the shoulder drive of the socket.

The reverse stop pin may incorporate a cam action that conveniently adjusts the initial grip exerted by the flexible ring upon the spigot drive of the fastening device thereby allowing convenient adjustment to the amount of ‘play ’ between the reverse and drive functions.

Preferably, the axis and fulcrum pins are retained by cylindrical apertures within the ends of the arms of the flexible ring portion whilst allowing the handle portion to pivot freely in relation to the flexible ring portion without undue play.

According to another aspect of the present invention there is provided drive means comprising a circular-section spigot extending coaxially from a tool engageable with a fastener means.

One known socket is driven by gripping an appropriate shoulder drive section located on the outer surface of the socket allowing the socket to be improved because the usual axially located square drive is no longer required and part of the fastener or screw thread upon which the fastener is located can protrude through an open central aperture of the socket.

In an alternative embodiment, the flexible ring can be provided with an inner surface which is of a generally polygonal shape to usefully engage hexagonal headed fasteners to tighten or slacken the fasteners or to drive a pin square drive in order to drive known sockets or drive bits.

Preferably, a known spring mechanism repositions the flexible ring portion and actuator during the non-drive reverse/repositioning sequence.

### DESCRIPTION OF THE INVENTION

Embodiments of the present invention will now be described by way of example only with reference to the accompanying drawings in which:

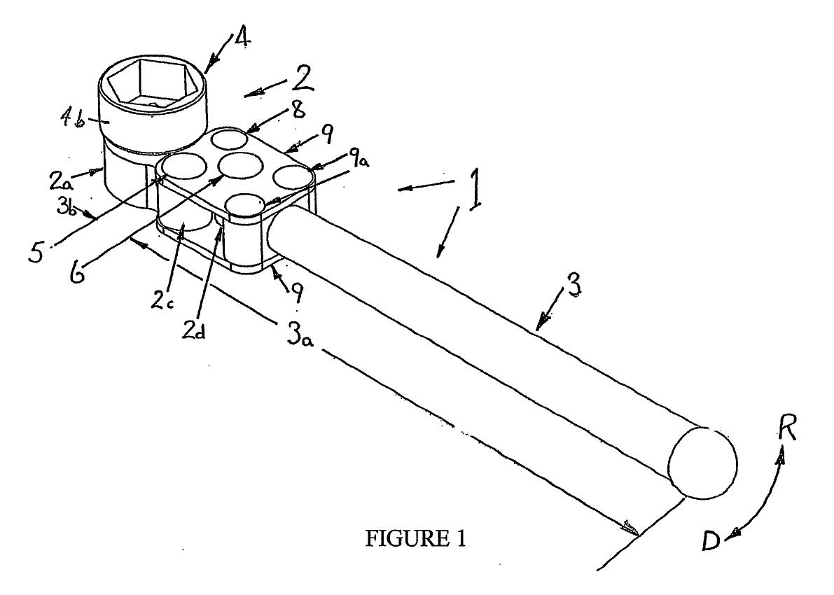

FIG. 1 is a perspective view of a wrench in accordance with the present invention having a clamp drive socket bar with a socket located within a flexible ring of the socket bar;

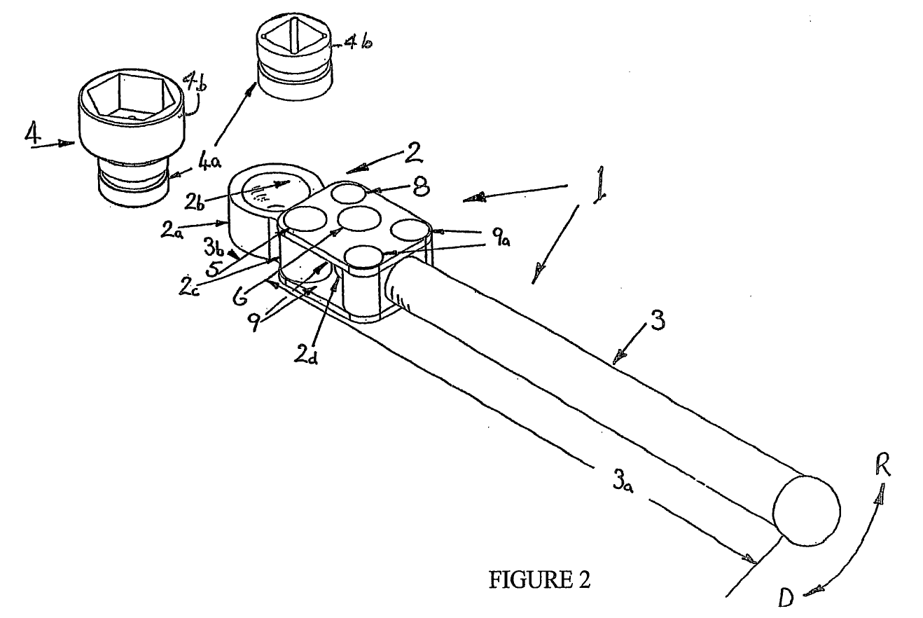

FIG. 2 is a perspective view of the clamp drive socket bar of FIG. 1 with sockets shown separately;

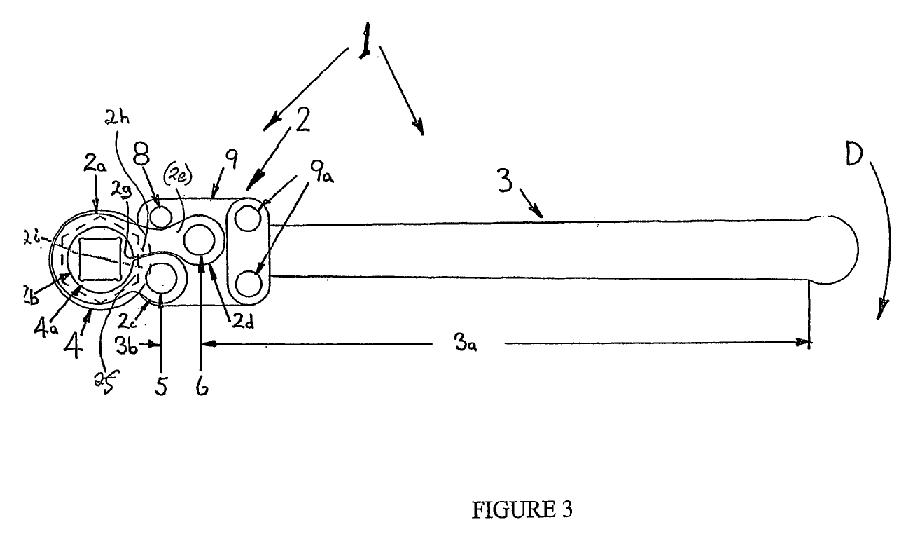

FIG. 3 is a side elevational view of the clamp drive socket bar in a non drive mode, and with one adjacent plate removed to illustrate an internal locking mechanism;

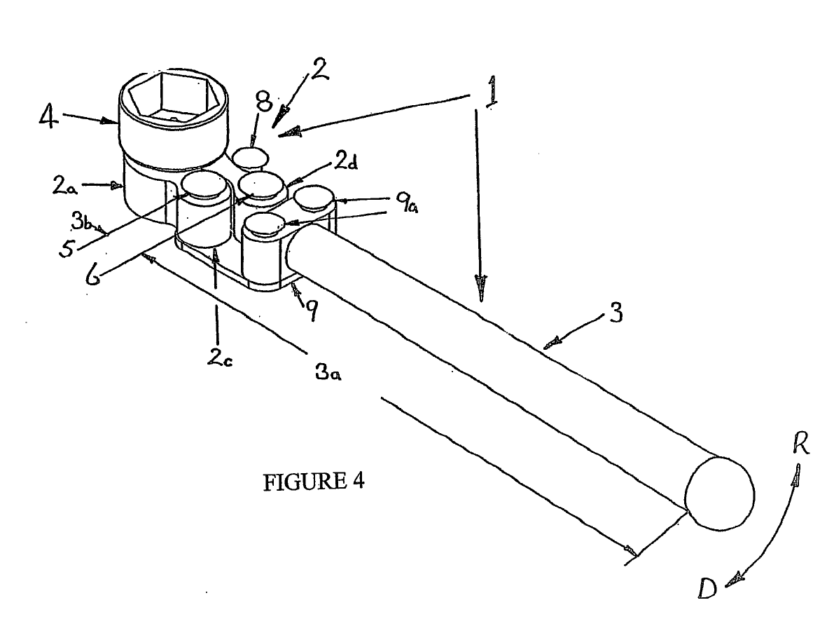

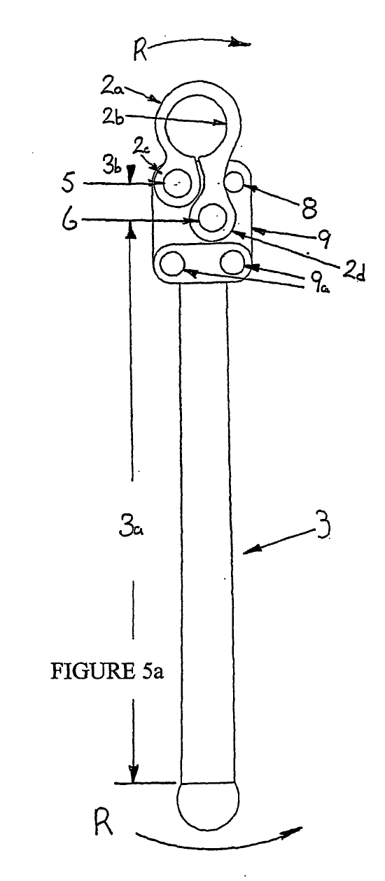

FIG. 4 is a perspective view of the clamp drive socket bar of FIG. 3;

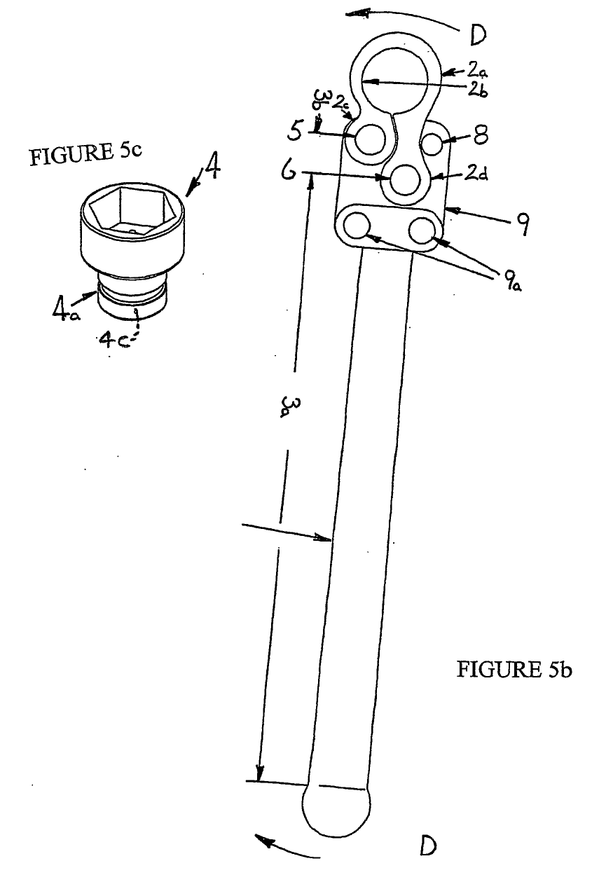

FIGS. 5a and b are side elevational views of the clamp drive socket bar of FIG. 3, FIG. 5a showing a central rest position and FIG. 5b a drive position;

FIG. 5c is a perspective view of a drive socket having an external cylindrical gripping surface; and

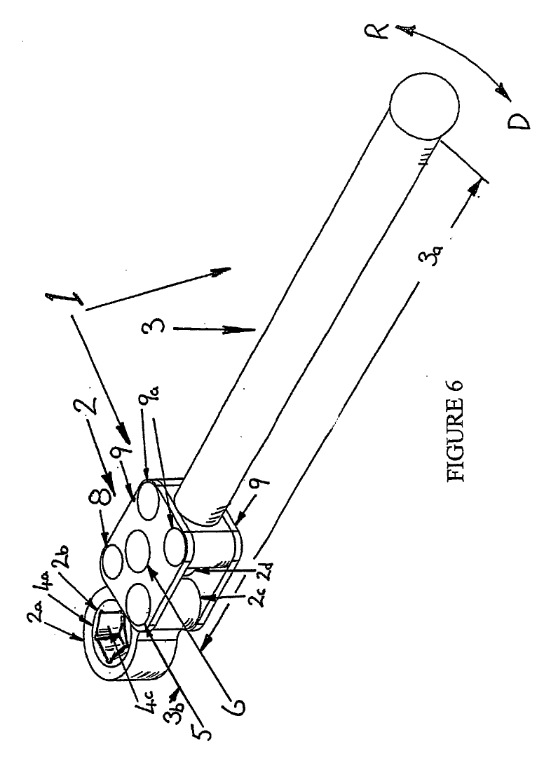

FIG. 6 shows a perspective view of the clamp drive socket bar in which the flexible ring drive portion has a hexagonal inner surface for direct application to hexagonal headed fasteners or a known square drive.

### DESCRIPTION OF THE EMBODIMENTS

The embodiments of the present invention will now be described with reference to the accompanying drawings. In the various embodiments described herein and corresponding drawings, like reference numerals are used to indicate like features throughout.

Referring to FIGS. 1 to 6 of the drawings, there is shown a wrench having a clamp drive socket bar (1) which includes a flexible head portion (2) formed of spring steel for example and connected with an elongate handle (3) for applying torque to socket (4) having a drive spigot (4a) with an external cylindrical drive surface (4b). When applying torque in a direction D the flexible ring portion tightens onto the socket to drive the socket. The flexible ring portion (2) freely rotates about the socket (4) when the handle portion (3) is operated in a re-position or reverse direction (R).

The head portion (2) is coupled with the handle (3) by an operable mechanism (9) for allowing the head portion (2) to be tightened onto or released from the drive spigot of socket or fastening device (4).

The operable mechanism (9) comprises two adjacent spaced parallel plates (10) fixed to a handle (3) by pins or rivets (9a) adjacent the handle. A fulcrum pin (5) and an axis pin (6) also interconnect plates (10) and simultaneously serve to attach the flexible head portion (2) between the plates (10) and mechanically hold the handle (3) and head portion together.

The head portion (2) includes a flexible ring (2a) having a cylindrical inner working surface (2b) for engagement with a cylindrical drive spigot (4a) of the socket (4).

As shown in FIG. 3 the flexible ring (2a) has a generally radially extending gap (2g) between opposed ring ends (2h) and (2i) thereof. An elongate arm (2e) extends in a radial direction outwardly from ring end (2h) and a shorter arm (2c) than arm (2e) extends in a radial direction outwardly from ring end (2i). The two arms (2h) and (2i) are closely spaced one from the other by gap (2g) in the inoperative condition of the clamp drive socket bar (1). A circular aperture is provided at each end of the arms (2c), (2e) for receiving therein the fulcrum pin (5) and axis pin (6) respectively. The ring arms (2c) and (2e) are both rotatable relative to their respective fulcrum pin 5 and axis pin 6.

The ring (2a) is flexible so as to move towards and clamp onto the cylindrical drive surface of socket (4) in an operative condition of the wrench with the gap (2g) closed or substantially closed and the ends (2h) and (2i) of the ring (2a) touching or substantially touching. When the drive torque is removed the flexible ring begins to spring open releasing drive pressure upon the socket. However, full opening movement of the flexible ring is prevented substantially by stop pin (8) which engages the side of arm (2e) remote from arm (2c) to establish gap (2g) and allowing free movement of the wrench around the drive shoulder of the socket (4).

In operation of the clamp drive socket bar with torque applied in direction D the handle (3) pivots around axis pin (6).

The torque applied to the lever end (3a) of the handle (3) is substantially increased by the mechanical advantage of the lever action and the resultant force acts on the levered end (3b) onto the fulcrum pin (5) rotatably fitted through arm (2c) of smaller arm (2f). The fulcrum pin (5) acts on the small arm (2c) of the flexible ring (2a) closing the gap (2g) and forcing the inner surface. (2b) of the flexible ring (2a) onto the shoulder drive surface (4a) of the fastening socket (4) or alternatively the circular drive (4b) serves to lock the flexible ring (2a) and the drive portions (4a or 4b) together. The torque applied to the handle portion (3) is then usefully used to operate a known fastener or alternatively through a polygonal or square recess (4c) and complementary socket square drive (7) to operate a known fastener.

Undue slippage of the flexible ring (2a) is prevented by applying a resilient biasing force upon the shoulder drive (4a) of the socket (4). This biasing force substantially decreases when the handle (3) is operated in the reverse drive direction (R). The degree of friction between the flexible ring inner surface (2b) and shoulder drive outer surface (4a) reduces and the flexible ring (2a) opens just enough, as disclosed above, to form gap (2g), and to allow the flexible ring (2a) to rotate relative to the socket (4).

The stop pin (8) prevents rotational movement of the flexible ring (2a) relative to the handle portion (3) when the clamp drive socket bar (1) is operated in the reverse direction (R). The pin (8) is used as a tension adjuster when the handle moves in direction R and acts as a cam against the flexible ring (2a) through longer arm (2e) adjusting the resilient bias of the flexible ring (2a) upon the socket (4) or circular drive (4b). Preferably the head portion (2) is joined to the handle portion (3) by the plates (10) via joining pins (9a). Alternatively, the joining plates are incorporated as part of the handle (3).

There is also disclosed herein socket (4) which is a fastening device operative to drive a fastener when in turn driven by a wrench in accordance with the present invention.

As shown in the drawings, particularly FIGS. 2 and 5c, the socket (4) comprises a cylindrical drive portion (4b) having an internal surface shaped and sized in a conventional manner to fit over a fastener of a prescribed size. A reduced diameter coaxial cylindrical shoulder portion (4a) is integrally formed with the drive socket portion and preferably has a central recess (4c) therethrough of a size sufficient to allow a screw thread on which the fastener is mounted to pass therethrough if necessary in use of the fastening device.

In an alternative form the central recess in the shoulder portion may have a square cross-section to accommodate a conventional square cross-section drive pin. Such drive pin is driven by a corresponding cross-sectional inner surface of the flexible ring (2a) of the wrench in accordance with the present invention.

In a further embodiment the socket portion (4b) and shoulder portion (4a) are of the same diameter and the two portions may be separated by a groove (4d), FIG. 2.

The groove (4d) may otherwise be located around the shoulder portion (4a) as shown in FIGS. 2 and 5c. The groove (4d) in the shoulder portion (4a) serves to assist in securing the relative location between the shoulder portion and the inner surface (2b) of the flexible ring (2a) by receiving a detent (not shown) extending from the inner surface (2b) of the flexible ring.

In any of the embodiments of the socket described above the shoulder portion (4a) is of a constant diameter for any size of drive socket portion (4b). Accordingly, all sockets of a set of sockets can be provided with a cylindrical shoulder portion (4a) of the same diameter for each socket and a wrench device as described herein with reference to the present invention.

Advantageously, the wrench device of the present invention can operate efficiently to tighten a fastener in situations where there is little space to operate without the need to rely on ratchet teeth. The flexible ring (2a) operates immediately when the handle is moved in direction D to grip the drive spigot of the fastening device. Furthermore, torque increases to grip the drive spigot tighter the more the handle is forced in direction D. Therefore, the chance of slippage is removed whether the drive occurs between two cylindrical surfaces or hexagonal surfaces. Additionally, the wrench can be applied directionally to fasteners of various sizes using the one flexible ring.

1. A wrench device comprising a handle and resiliently movable clamping means mounted on the handle, the clamping means comprising spaced means for connecting the clamping means with the handle, the spaced means being located at offset locations both laterally and longitudinally relative to a longitudinal axis of the handle so that movement of the handle in a drive direction moves the spaced means one relative to the other to clamp the clamping means on a fastener for moving the fastener.

2. A device as claimed in claim 1, wherein the clamping means has two spaced ends movable towards each other to effect clamping to turn the fastening device, or movable away from each other to release the clamping force.

3. A device as claimed in claim 2, wherein each spaced end of the resilient movable clamping member has an arm, extending radially outwardly therefrom.

4. A device as claimed in claim 3, wherein the arms are of unequal length.

5. A device as claimed in claim 3, wherein the arms extend outwardly side-by-side closely spaced on from the other.

6. A device as claimed in claim 3, wherein the end of each arm remote from the resilient movable clamping member has an aperture therethrough.

7. A device as claimed in claim 6, wherein the slot is of a constant width along its length.

8. A device as claimed in claim 7, wherein the pivot means comprises a pivot pin in each instance supported between two spaced plates extending axially of the handle.

9. A device as claimed in claim 8, comprising a stop pin supported between the spaced plates, for preventing movement of one arm when releasing the wrench from driving the fastening device.

10. A device as claimed in claim 8, wherein the handle is elongate and secured to the two spaced plates on the diametrically opposite side of the pivot pin remote from the resilient movable means.

11. A device as claimed in claim 1, wherein the resilient movable means comprises an annular ring element having a gap defined by spaced ends thereof.

12. A wrench as claimed in claim 11, wherein the cylindrical surfaces of the axis pin corresponds to the diameter of the bulbous end of the slot and opposed recesses so that the axis pin can rotate therein.

13. A drive as claimed in claim 12, comprising a drive socket portion adapted to fit a particular size of fastener and the spigot comprises a shoulder portion having an external cylindrical surface for engagement by a wrench having a flexible head portion with an internal cylindrical drive surface.

14. A drive as claimed in claim 13, comprising an annular groove in the external cylindrical surface of the shoulder portion.

15. A socket as claimed in claim 13, wherein the shoulder portion is of a reduced diameter relative to that of the drive socket portion.

16. A socket set comprising a plurality of drive means as claimed in claim 12.
